(19) United States
(12) Patent Application Publication
(10) Pub. No.: US 2023/0180793 A1
(43) Pub. Date: Jun. 15, 2023

(54) FISH FOOD COMPOSITION AND ITS USE

(71) Applicant: OASE GmbH, Hörstel-Riesenbeck (DE)

(72) Inventor: Thorsten Muck, lbbenburen (DE)

(73) Assignee: OASE GmbH, Hörstel-Riesenbeck (DE)

(21) Appl. No.: 18/080,500

(22) Filed: Dec. 13, 2022

(30) Foreign Application Priority Data
Dec. 13, 2021 (EP) 21214066.9

(51) Int. Cl. A23K 10/30; A23K 50/80; A23K 20/142; A23K 20/174; A23K 20/179

(52) U.S. Cl. CPC A23K 10/30; A23K 50/80; A23K 20/142; A23K 20/174; A23K 20/179

(57) ABSTRACT

Provided are fish food compositions that include 40-70 wt. % cereal flour, 15-30 wt. % meal from aquatic animals, 10-20 wt. % extraction meal, 0.01-0.40 wt. % pepper, and 0.1-1.0 wt. % free methionine. Also provided are methods for using the fish food compositions as a fish food for ornamental fish.

### FIELD OF THE INVENTION

The invention relates to fish food compositions and their use for feeding ornamental fish.

### BACKGROUND

Commercial fish food consists in principle of proteins, fats, carbohydrates, mineral components, collagens, and additives such as vitamins and trace elements. For example, in DE 10 2004 048 949 A1 a fish food containing water-soluble astaxanthin as a food additive in fish farming for pigmentation of salmon and trout is described. EP 1 346 647 A1 describes a fish food for rearing salmon.

With regard to the physiological usability of the proteins in the fish food, it depends in particular on their composition. Carbohydrates tend to cause obesity in fish, especially the more complex the structure of the carbohydrates. With regard to fats in fish food, a higher proportion of omega-3 fatty acids and a lower proportion of omega-6 fatty acids is desirable. If amino acids are a component of fish food, the proportion of essential amino acids should not be too low, while the ratio of essential amino acids to the remaining amino acids must fit. Otherwise, amino acids are metabolized by fish and converted to ammonia, which can lead to pollution of water, especially due to excretions, and internal poisoning of fish.

Conventional fish foods are often designed for the rapid growth of fish. The main components of such fish foods are fat, carbohydrates, and amino acids. Furthermore, many different carbohydrate and protein sources are often used, which, however, can promote the obesity of the fish. Since higher slaughter weights are achieved with shorter rearing times (1-2 years), the natural life expectancy of the animals is not important.

Accordingly, there is a need for the development of a balanced, healthy, and cost-effective fish food that has a high acceptance by fish, supports their development in the long term and promotes the improvement of water quality.

### SUMMARY OF THE INVENTION

In a first aspect, the present invention provides a fish food composition comprising 40-70 wt. % cereal meal, 15-30 wt. % meal from aquatic animals, 10-20 wt. % extraction meal, 0.01-0.40 wt. % pepper, and 0.1-1.0 wt. % free methionine, wherein the weight percentages are based on the total weight of the fish food composition. The inventors have found that the fish food composition according to the invention promotes balanced development of fish, has a high food coefficient, and improves protein utilization and digestibility. Furthermore, it reduces the adiposity of fish and minimizes the pollution of the water in which the fish are kept. In addition, the price can be reduced due to the small number of different protein and hydrocarbon sources.

In a further aspect, the use of the fish food composition according to the first aspect is provided as a fish food for ornamental fish. The above effects and advantages are particularly pronounced in ornamental fish.

Further aspects of the present invention are found in the dependent claims and the detailed description.

### DETAILED DESCRIPTION OF THE INVENTION

### Definitions

Unless otherwise defined, technical and scientific terms used herein have the same meaning as commonly understood by the person skilled in the art of the invention.

Quantities in the context of the present invention refer to % by weight, unless otherwise indicated or apparent from the context.

In the context of the invention, the term “methionine” is not particularly limited. As is generally known, methionine is a sulfur-containing α-amino acid. In certain embodiments, methionine comprises a racemic mixture of L-methionine and D-methionine. According to some embodiments, methionine refers to L-methionine.

The term “free methionine” is not particularly limited. As is generally known, a free amino acid is not bound as a component of a protein or other molecule, but is present in a free form. Accordingly, the term “free methionine” according to some embodiments refers to the unbound form of methionine. In particular, the free methionine is not a component of a protein. L-methionine is found, for example, in raw beef, raw chicken meat, raw salmon, chicken egg, cow's milk, sesame seeds, Brazil nuts, walnuts, whole wheat flour, whole cornmeal, rice, buckwheat flour, soybeans, and peas. However, all these foods contain virtually exclusively chemically bound L-methionine as a protein component, but no free L-methionine.

The term “DL-methionine” is not particularly limited. As is generally known, DL-methionine refers to a racemic mixture of L-methionine and D-methionine.

“Aquatic animals” are not particularly limited in the context of the invention. As is generally known, an aquatic animal is an animal that lives in water. In certain embodiments, aquatic animals include fish, krill, shrimp, crabs, and bivalves.

The term “fermented rice” is not particularly limited. In general, “fermented rice” refers to red fermented rice produced from cooked white rice by fermentation using yeast and/or molds.

In the context of the present invention, “extraction meal” is not particularly limited. As is generally known, extraction meal is a form of oil meal. It is produced as a by-product in the extraction of vegetable oils by hot pressing or extraction processes. In this process, the extraction agent residues are removed by means of steam. According to some embodiments, “extraction meal” refers to soybean extraction meal.

The term “antioxidant” is not particularly limited in the context of the invention. As is generally known, antioxidants are chemical compounds which slow down or completely prevent oxidation of other substances. In the present invention, antioxidants commonly used in the animal food industry and in particular the fish food industry may be used.

In the context of the present invention, the term “colorant” is not particularly limited, except that the colorant is one that is compatible with fish.

The term “ornamental fish” or “ornamental fishes” is not particularly limited. As is generally known, ornamental fishes are any species of fish that are kept in aquariums and/or ponds for their appearance. According to some embodiments, ornamental fish are aquarium fish and/or pond fish.

“Freshwater fish” are not particularly limited in the context of the present invention. Freshwater fish, as is generally known, inhabit inland waters, lakes, and rivers. In certain embodiments, “freshwater fish” refer to aquarium fish and/or pond fish.

The term “food coefficient” is not particularly limited. A food coefficient is generally understood to be the ratio of the weight gain of the fed animal to the weight of the food fed. Accordingly, the food coefficient is a measure of food utilization. In certain embodiments, the food coefficient is equal to the ratio of the weight gain of the fed fish to the amount of fish food fed, for example in kilograms. In particular, the food coefficient is calculated according to the following formula:

$$food coefficient [ \% ] = \frac{weight gain of fish [ kg ]}{amount of fish food fed [ kg ]}$$

A first aspect of the invention relates to a fish food composition comprising 40-70 wt. %, preferably 55-60 wt. % cereal meal, 15-30 wt. %, preferably 20-25 wt. % meal from aquatic animals, 10-20 wt. %, preferably 14-18 wt. % extraction meal, 0.01-0.40 wt. %, preferably 0.05-0.2 wt. % pepper, and 0.1-1.0, preferably 0.2-0.5 wt. % free methionine, wherein the weight percentages are based on the total weight of the fish food composition. According to some embodiments, the fish food composition is a fish food composition for ornamental fish. In the context of the present invention, the terms “fish food composition” and “fish food” may be used equivalently.

The fish food composition according to the invention shows a high acceptance by fish, especially ornamental fish. By high acceptance is meant the willingness of the fish to eat the food. Furthermore, the water in which fish are kept that are fed the fish food composition according to the invention has low nitrogen and phosphorus contents. A low nitrogen content indicates that with the fish food composition according to the invention the ammonium, nitrate and nitrite load of the water does not particularly increase, whereas a low phosphorus content indicates a low phosphate load of the water and a good food utilization.

Without wishing to be bound to any particular theory, it is assumed that the aforementioned low water pollution is due to the high usability and digestibility of the fish food composition. For example, an insufficient proportion of essential amino acids and an inappropriate ratio of essential amino acids to remaining amino acids in the fish food results in an increased ammonium content of the water, which can be attributed, among other things, to the energetic metabolism of excess amino acids. Furthermore, the combination of pepper and free methionine is believed to promote protein utilization and digestibility of the fish food, as well as contribute to a high food coefficient. It is believed that the positive effects could be attributed to a prebiotic effect of pepper and methionine as an essential amino acid. The pepper releases piperine, which mobilizes a greater flow of digestive juices and thus may mediate a higher penetration of the food pulp, promoting osmotic and diffusive transport of nutrients into the organism, while methionine may eliminate limiting protein utilization. According to Liebig's minimal principle, the essential nutrient elements in the food pulp are better tapped and thus the overall usability of nutrients is improved.

In addition to the advantageous combination of pepper and free methionine, the fish food composition according to the invention has a low number of hydrocarbon and protein sources, a low fat content and a high omega-3 fatty acid content. This has been shown to achieve balanced growth and healthy development of fish. In particular, the adiposity of the fish is reduced and a high food coefficient is achieved. Accordingly, the fish food composition according to the invention is particularly suitable for healthy and sustainable feeding of fish. Furthermore, the price of the fish food composition is reduced due to the small number of different components.

According to certain embodiments, the fish food composition further comprises 0.1-4.0 wt. %, preferably 0.2-2.0 wt. % algae, 0.1-2.5 wt. %, preferably 0.2-1.5 wt. % fermented rice, and 0.01-0.10 wt. %, preferably 0.03-0.08 wt. % herbs, based on the total weight of the fish food composition. These ingredients in the amounts indicated further increase the acceptability of the fish food composition and further improve its digestibility. Furthermore, the fish food composition may contain 1.0-5.0 wt. %, preferably 2.0-3.0 wt. % wheat germs, based on the total weight of the 1.0 fish food composition. As a result, the digestibility and acceptability of the fish food composition can be further increased and the fish food can be better adapted to the needs of the respective fish species.

In some embodiments, the algae are selected from the group consisting of spirulina algae, seaweed, and mixtures thereof. This may further increase the nutrient content of the fish food composition. According to certain embodiments, the herbs are selected from the group consisting of thyme, sage, rosemary, fennel, anise, savory, and mixtures thereof. In preferred embodiments, the herbs are a herbal mixture of thyme, sage, rosemary, fennel, anise, and savory. Said herbs further improve the digestibility of the fish food composition and further increase its acceptability.

According to certain embodiments, the cereal flour is selected from the group consisting of wheat flour, cornmeal, rice flour, and mixtures thereof. In particular, wheat flour and/or cornmeal may form the main ingredient of the cereal flour. The selection of the cereal flour further reduces the hydrocarbon sources of the fish food composition, thereby further minimizing the fattening of the fish. In some embodiments, the meal from aquatic animals is selected from the group consisting of fish meal, krill meal, shrimp meal, and mixtures thereof. This further improves the digestibility of the fish food composition. In particular, fish meal may be the main ingredient of the meal from aquatic animals.

In some embodiments, the extraction meal of the fish food composition according to the invention is soybean extraction meal. Soybean extraction meal, also referred to as “soybean meal”, has a high protein content and is highly suitable as a protein source for the fish food composition according to the invention. The use of soybean extraction meal, in combination with methionine and pepper, can further improve the protein utilization and digestibility of the fish food composition. According to some embodiments, the free methionine is DL-methionine. Protein utilization and digestibility are further enhanced and fish adiposity is further reduced by the use of DL-methionine. In certain embodiments, the pepper is black pepper. The use of black pepper in the fish food composition according to the invention further increases the acceptability of the fish food composition as well as its digestibility, thereby further improving water quality. Furthermore, black pepper is less denatured and thus preferred. In particular, the pepper in the present fish food composition is in ground form.

According to certain embodiments, the fish food composition according to the invention contains additives. These may be selected from the group consisting of vitamins, antioxidants, colorant, choline chloride, inositol, and mixtures thereof. Further, the vitamins may be selected from the group consisting of vitamin A, vitamin D3, vitamin E, vitamin C, and mixtures thereof. The addition of vitamins promotes the development of fish and contributes to healthy nutrition. Antioxidants prolong the shelf life of fish food composition. Butylated hydroxytoluene may be used as a suitable antioxidant for the fish food composition according to the invention. Furthermore, canthaxanthin may be used as a colorant, which improves the appearance of the fish food composition and/or the fish. Choline chloride prevents liver damage in fish.

In some embodiments, the fish food composition comprises 50-60 wt. % wheat flour, 20-25 wt. % fish meal, 15-20 wt. % soybean extraction meal, 2-3 wt. % wheat germs, 1.0-1.5 wt. % spirulina algae, 0.1-1.0 wt. % shrimp meal, 0.1-1.0 wt. % krill meal, 0.1-1.0 wt. % fermented rice, 0.1-1.0 wt. % seaweed, 0.1-0.5 wt. % free DL-methionine, 0.01-0.50 wt. % pepper, 0.01-0.10 wt. % herbs, and additives as the remainder. The weight percentages refer to the total weight of the fish food composition and add up to 100 wt. % with the additives. By this fish food composition, the food coefficient, digestibility, protein utilization and water quality are further improved, and further the acceptability of the fish food is increased and the fatty degeneration of the fish is reduced. Furthermore, this composition has a low number of hydrocarbon and protein sources, a low fat content and a high omega-3 fatty acid content. In a preferred embodiment, this fish food composition is a fish food composition for Japanese ornamental carp, in particular koi carp.

According to certain embodiments, the fish food composition comprises 45-55 wt. % cornmeal, 20-25 wt. % fish meal, 15-20 wt. % soybean extraction meal, 8-12 wt. % wheat meal, 0.1-1.0 wt. % shrimp meal, 0.1-1.0 wt. % krill meal, 0.1-1.0 wt. % fermented rice, 0.1-1.0 wt. % seaweed, 1.0-1.5 wt. % spirulina algae, 0.1-0.5 wt. % free DL-methionine, 0.01-0.50 wt. % pepper, 0.01-0.10 wt. % herbs, and additives as the remainder. The weight percentages refer to the total weight of the fish food composition and add up to 100% by weight with the additives. This fish food composition further improves the food coefficient, digestibility, protein utilization and water quality, and further increases the acceptability of the fish food and reduces the fatty degeneration of the fish. Furthermore, this composition has a low number of hydrocarbon and protein sources, a low fat content and a high omega-3 fatty acid content. In a preferred embodiment, this fish food composition is a fish food composition for ornamental fish in garden ponds, in particular goldfish, minnows, bitterlings, moderlieschen, golden orfes and sunfish.

A second aspect of the present invention relates to the use of the fish food composition of the first aspect as a fish food for ornamental fish. Reference is made to the above discussion of the first aspect of the invention, which also applies to the second aspect of the invention. In ornamental fish, healthy and sustainable nutrition and balanced development are particularly important. Rapid weight gain is not required in this respect. Since the fish food composition of the first aspect, as described above, promotes protein utilization and digestibility, and has a high food coefficient and reduces adiposity, the fish food composition of the first aspect is particularly suitable as a fish food for ornamental fish. In addition, the fish food composition of the first aspect reduces the pollution of the water, which is particularly advantageous when keeping ornamental fish in aquariums and/or ponds. In this regard, the aforementioned effects are particularly pronounced when the ornamental fish are freshwater fish. In certain embodiments, the ornamental fish are selected from the group consisting of koi carp, goldfish, minnows, bitterlings, moderlieschen, golden orfes and sunfish. When the fish food composition of the first aspect is used as a fish food for these ornamental fish, the above effects are particularly pronounced.

In a particular embodiment, a fish food composition is used as a fish food for koi carp, wherein the fish food composition comprises 50-60 wt. % wheat flour, 20-25 wt. % fish meal, 15-20 wt. % soybean extraction meal, 2-3 wt. % wheat germs, 1.0-1.5 wt. % spirulina algae, 0.1-1.0 wt. % shrimp meal, 0.1-1.0 wt. % krill meal, 0.1-1.0 wt. % fermented rice, 0.1-1.0 wt. % seaweed, 0.1-0.5 wt. % free DL-methionine, 0.01-0.50 wt. % pepper, 0.01-0.10 wt. % herbs, and additives as the remainder. The weight percentages refer to the total weight of the fish food composition and add up to 100 wt. % with the additives. The effects with respect to such a fish food composition are described in the above discussion of the first aspect of the invention.

According to a particular embodiment, a fish food composition is used as a fish food for goldfish, minnows, bitterlings, moderlieschen, golden orfes, and sunfish, wherein the fish food composition comprises 45-55 wt. % cornmeal, 20-25 wt. % fish meal, 15-20 wt. % soybean extraction meal, 8-12 wt. % wheat flour, 0.1-1.0 wt. % shrimp meal, 0.1-1.0 wt. % krill meal, 0.1-1.0 wt. % fermented rice, 0.1-1.0 wt. % seaweed, 1.0-1.5 wt. % spirulina algae, 0.1-0.5 wt. % free DL-methionine, 0.01-0.50 wt. % pepper, 0.01-0.10 wt. % herbs, and additives as the remainder. The weight percentages refer to the total weight of the fish food composition and add up to 100 wt. % with the additives. The effects with respect to such a fish food composition are described in the above discussion of the first aspect of the invention.

The manufacturing process of the fish food composition according to the invention is not particularly limited. In general, known fish food manufacturing processes can be used. According to some embodiments, the manufacturing process is an extrusion process. In some embodiments, the fish food composition may be manufactured by roller drying.

In certain embodiments, the fish food composition may be prepared by weighing and mixing the individual components of the fish food composition in their respective proportions by weight. Then, the mixture may be sieved (for example, with a mesh size of 630 μm and/or 1000 μm) and then extruded at about 90° C. The extruded mixture may be dried at about 60° C. for 20 min to obtain an exemplary fish food composition according to the invention.

According to some embodiments, the fish food composition may be prepared by weighing and mixing the individual components of the fish food composition in their respective proportions by weight. The mixture may then be rolled into a film using a roller dryer and dried at about 90° C. for 5 min. The dried film may then be scraped off to provide an exemplary fish food composition according to the invention.

### EXAMPLES

The invention is further explained in detail below with reference to various examples thereof. However, the invention is not limited to these examples.

### Example 1

Fish Food Composition for Koi Carp

A fish food composition for koi carp was prepared by extrusion in the form of pellets (3-4 mm diameter). The fish food composition had the following ingredients (see Table 1).

TABLE 1
Ingredients of an exemplary fish food composition for koi carp

| Ingredient | Quantity [wt %] |
|---|---|
| Wheat flour | 56.22 |
| Fishmeal | 21.5 |
| Soybean extraction meal | 16 |
| Wheat Germs | 2.5 |
| Spirulina algae, dried | 1.38 |
| Shrimp meal | 0.5 |
| Krill meal | 0.5 |
| Rice (fermented) | 0.5 |
| Seaweed, dried | 0.25 |
| DL-methionine | 0.25 |
| Pepper | 0.1 |
| Herbal premix* | 0.05 |
| Additives** | Rest of total |
| | 100 wt. % |

*Herbal premix of thyme, sage, rosemary, fennel, anise, savory.
**Additives: vitamin A, vitamin D₃, vitamin E, vitamin C, canthaxanthin, butylated hydroxytoluene.

The analytical components of the fish food composition are shown in Table 2.

TABLE 2
Analytical components of an exemplary
fish food composition for koi carp

| Component | Quantity [wt %] |
|---|---|
| Crude protein | 30.0 |
| Crude fat | 4.5 |
| Crude fiber | 3.5 |
| Crude ash | 7.0 |
| Calcium | 1.3 |
| Phosphorus | 1.0 |
| Protein:fat ratio | 6.7:1 |

As shown in Table 2, the exemplary fish food composition had a high crude protein content and a low fat content. Furthermore, the exemplary fish food composition showed high acceptance when fed to koi carp.

### Example 2

Fish Food Composition for Ornamental Fish in the Garden Pond

A fish food composition for ornamental fish in the garden pond was prepared by extrusion in the form of sticks. The fish food composition had the following ingredients (see Table 3).

TABLE 3
Ingredients of an exemplary fish food composition
for ornamental fish in the garden pond

| Ingredient | Quantity [wt %] |
|---|---|
| Cornmeal | 49 |
| Fishmeal | 22 |
| Soybean extraction meal | 15.84 |
| Wheat flour | 10.5 |
| Shrimp meal | 0.5 |
| Krill meal | 0.5 |
| Rice (fermented) | 0.5 |
| Spirulina algae, dried | 0.25 |
| Seaweed, dried | 0.25 |
| DL-methionine | 0.25 |
| Pepper | 0.1 |
| Herbal premix* | 0.05 |
| Additives** | Rest of total |
| | 100 wt. % |

*Herbal premix of thyme, sage, rosemary, fennel, anise, savory.
**Additives: vitamin A, vitamin D₃, vitamin E, vitamin C, canthaxanthin, butylated hydroxytoluene.

The analytical components of the fish food composition are shown in Table 4.

TABLE 4
Analytical components of an exemplary fish food
composition for ornamental fish in garden ponds

| Component | Quantity [wt %] |
|---|---|
| Crude protein | 28.0 |
| Crude fat | 4.0 |
| Crude fiber | 2.5 |
| Crude ash | 6.5 |
| Protein:fat ratio | 7.0:1 |

As shown in Table 2, the exemplary fish food composition had a high crude protein content and a low fat content. Furthermore, the exemplary fish food composition showed high acceptance when fed to ornamental fish in the garden pond, but also to koi carp.

### Comparative Example 1

Commercial Fish Food Composition for Pond Fish A

A commercially available fish food composition consisting of cornmeal, wheat flour, salmon flour, soybean flour, rice flour, wheat germs, shrimp flour, spinach, spirulina, yeast extract, apple extract and green flour was analyzed for its analytical constituents. The results are shown in Table 5.

TABLE 5
Analytical constituents of a commercially available
fish food composition for pond fish A

| Component | Quantity [wt %] |
|---|---|
| Crude protein | 23 |
| Crude fat | 5.1 |
| Crude fiber | 1.9 |
| Crude ash | 5.6 |
| Protein:fat ratio | 4.5:1 |

### Comparative Example 2

Commercial Fish Food Composition for Pond Fish B

A commercially available fish food composition consisting of vegetable by-products, cereals, vegetable protein extracts, fish and fish by-products, oils and fats, minerals, algae and yeasts was analyzed for its analytical constituents. The results are presented in Table 6.

TABLE 6
Analytical constituents of a commercially available
fish food composition for pond fish B

| Component | Quantity [wt %] |
|---|---|
| Crude protein | 28.8 |
| Crude fat | 5.4 |
| Crude fiber | 0.9 |
| Crude ash | 5.0 |
| Protein:fat ratio | 5.3:1 |

The above embodiments, configurations and implementations can be combined with each other as desired, if useful. Further possible embodiments, configurations and implementations of the invention also include combinations of previously described features of the invention that are not explicitly mentioned. In particular, the person skilled in the art will also add individual aspects as improvements or additions to the respective basic form of the present invention.

1. A fish food composition, comprising:
40-70 wt. % cereal flour;
15-30 wt. % of meal from aquatic animals;
10-20 wt. % extraction meal;
0.01-0.40 wt. % pepper; and
0.1-1.0 wt. % free methionine;
based on the total weight of the fish food composition.

2. The fish food composition of claim 1, further comprising:
0.1-4.0 wt. % algae;
0.1-2.5 wt. % fermented rice; and
0.01-0.10 wt. % herbs; and
optionally 1.0-5.0 wt. % wheat germs
based on the total weight of the fish food composition.

3. The fish food composition according to claim 2, wherein the algae are selected from the group consisting of spirulina algae, seaweed, and mixtures thereof, optionally wherein the herbs are selected from the group consisting of thyme, sage, rosemary, fennel, anise, savory, and mixtures thereof.

4. The fish food composition according to claim 1, wherein the cereal flour is selected from the group consisting of wheat flour, cornmeal, rice flour, and mixtures thereof.

5. The fish food composition according to claim 1, wherein the meal from aquatic animals is selected from the group consisting of fish meal, krill meal, shrimp meal, and mixtures thereof.

6. The fish food composition according to claim 1, wherein the extraction meal is soybean extraction meal.

7. The fish food composition according to claim 1, wherein the free methionine is DL-methionine.

8. The fish food composition according to claim 1, wherein the pepper is black pepper.

9. The fish food composition according to claim 1, wherein the fish food composition further comprises one or more additives selected from the group consisting of vitamins, antioxidants, colorant, choline chloride, inositol, and mixtures thereof.

10. The fish food composition according to claim 9, wherein the vitamins are selected from the group consisting of vitamin A, vitamin D3, vitamin E, vitamin C, and mixtures thereof,

11. The fish food composition according to claim 1, wherein the colorant is canthaxanthin.

12. The fish food composition according to claim 1, wherein the antioxidant is butylated hydroxytoluene.

13. The fish food composition according to claim 1, where the fish food composition consists of:
50-60 wt. % wheat flour;
20-25 wt. % fish meal;
15-20 wt. % soybean extraction meal;
2-3 wt. % wheat germs;
1.0-1.5 wt. % spirulina algae;
0.1-1.0 wt. % shrimp meal;
0.1-1.0 wt. % krill meal;
0.1-1.0 wt. % fermented rice;
0.1-1.0 wt. % seaweed;
0.1-0.5 wt. % free DL-methionine;
0.01-0.50 wt. % pepper;
0.01-0.10 wt. % herbs; and
additives as the remainder,
based on the total weight of the fish food composition.

14. The fish food composition according to claim 1, wherein the fish food composition consists of:
45-55 wt. % cornmeal;
20-25 wt. % fish meal;
15-20 wt. % soybean extraction meal;
8-12 wt. % wheat flour;
0.1-1.0 wt. % shrimp meal;
0.1-1.0 wt. % krill meal;
0.1-1.0 wt. % fermented rice;
0.1-1.0 wt. % seaweed;
1.0-1.5 wt. % spirulina algae;
0.1-0.5 wt. % free DL-methionine;
0.01-0.50 wt. % pepper;
0.01-0.10 wt. % herbs; and
additives as the remainder,
based on the total weight of the fish food composition.

15. A method for feeding ornamental fish, the method comprising providing to the ornamental fish the fish food composition according to claim 1.

16. The method according to claim 15, wherein the ornamental fish are freshwater fish.

17. The method according to claim 15, wherein the ornamental fish are selected from the group consisting of koi carp, goldfish, minnows, bitterlings, moderlieschen, gold orfes, and sunfish.
